(19) United States
(12) Patent Application Publication
(10) Pub. No.: US 2017/0036622 A1
(43) Pub. Date: Feb. 9, 2017

(54) POWER TRANSMISSION DEVICE AND VEHICLE ELECTRICAL SYSTEM

(71) Applicant: ROBERT BOSCH GMBH, Stuttgart (DE)

(72) Inventors: Matthias HORN, Leonberg (DE); Christian Bohne, Stuttgart (DE)

(21) Appl. No.: 15/303,283

(22) PCT Filed: Mar. 5, 2015
(86) PCT No.: PCT/EP2015/054679

§ 371 Date: Oct. 11, 2016

(30) Foreign Application Priority Data
Apr. 29, 2014 (DE) 10 2014 207 993.4

(51) Int. Cl. B60R 16/033; B60L 11/18; H02M 3/04; B60L 11/02

(52) U.S. Cl. CPC B60R 16/033; B60L 11/02; B60L 11/18; H02M 3/04

(57) ABSTRACT

A power transmission device including at least one first input terminal and a second input terminal for the at least dual-channel supply of electric power to the power transmission device, and including at least one output terminal for routing the electric power to a consumer, the power transmission device including an input switch which is designed for the electrically conductive connection of the first input terminal and/or the second input terminal to the at least one output terminal. Furthermore, a vehicle electrical system including such a power transmission device is also provided.

### FIELD

The present invention relates to a power transmission device for use in a vehicle electrical system of a vehicle, and a vehicle electrical system including such a power transmission device.

### BACKGROUND INFORMATION

Due to the increasing electrification of power plants and the introduction of new driving functions, the reliability requirements placed on the electrical power supply in vehicles and motor vehicles are increasing.

In the case of highly automated driving in the future, activities not involving driving are permissible to a limited extent. A sensor, control, mechanical, and power backup is only partially provided by a driver in this case. The present conventional 14 V vehicle electrical system is no longer sufficient for handling the increased requirements for the reliability of the electrical supply.

The power distribution in such a vehicle electrical system may take place passively via fuse boxes without controller intervention. A diagnosis of vehicle electrical system faults or component faults are not provided. Thus, in the event of a fault, it is possible that no actions are taken in order to ensure a power supply to safety-relevant components for providing fault compensation.

European Patent No. EP 1 054 789 B1 describes a method for connecting and disconnecting consumers, in which the required information which indicates the present operating states of the consumers is conveyed to a control unit.

A consumer for interior illumination may be connected to a body computer module (BCM). In this case, the consumer may be controlled via an output stage. For example, if a light bulb of the consumer fails, this may be detected by the output stage and reported to the vehicle driver.

However, there is still the need to increase the reliability of the electrical power supply of safety-relevant components.

### SUMMARY

The present invention provides a power transmission device as described herein.

One aspect of the present invention is that a power transmission device is provided which optionally enables a supply of consumers with electric power via a first channel which is electrically conductively connected to a first input terminal of the power transmission device, and/or via a second channel of the power transmission device which is electrically conductively connected to a second input terminal. This increases the reliability of the electrical power supply of safety-relevant components and thus increases the overall operating safety. The selection of the input terminal takes place with the aid of an input switch. The power transmission device includes at least one, preferably at least two output terminals, to which one or multiple consumers may be connected with the aid of output lines.

According to one specific embodiment, the input switch is designed as a changeover switch. The changeover switch establishes an electrically conductive connection with either the first input terminal or the second input terminal. The disconnection of an electrically conductive connection at the one input terminal is accompanied by an electrically conductive connection of the other input terminal. Thus, supplying the consumers with electric power may take place via the first channel or the second channel, but not via the two channels simultaneously.

According to an additional specific embodiment, the power transmission device is designed to control the input switch in such a way that a switch from the first input terminal to the second input terminal or vice-versa is carried out, in response to the detection of an undershooting of a limiting value for the level of a voltage and/or for the strength of an electric current at the first input terminal and/or the second input terminal. For this purpose, for example, a measuring device of the power transmission device detects the voltage and/or the electric current at the first channel and/or the second channel, while, for example, a control unit compares the detected values for the voltages and/or the electric currents with limiting values, and in response to the result of the comparison, effectuates a switch from, for example, the first channel to the second channel. Thus, no additional components are necessary in order to effectuate a switch from the first channel to the second channel or vice versa.

According to an additional specific embodiment, an output switch is associated with the at least one output terminal for breaking the connection and thus the supply of one consumer with electric power in each case. As a result, it is achieved that an output line for supplying consumers may be disconnected in the event of a fault with the aid of the output switch, while the power supply of the remaining consumers is unaffected by the fault. Thus, the reliability of the power supply is increased. The output switch may preferably be a mechanical switch or an electronic semiconductor switch.

According to an additional specific embodiment, the power transmission device is designed for radially supplying the consumers with electric power. As a result, a particularly simple supply of the consumers with electric power is possible without a bus system.

According to an additional specific embodiment, the power transmission device includes a measuring device which is designed for detecting a short circuit between the at least one output terminal and a voltage supply potential (typically denoted by V+, V−, and/or GND or ground), and/or a disruption in an electrical line connected to the at least one output terminal (“open output”) and/or between multiple output terminals (if the power transmission device includes at least two output terminals), the power transmission device including a control unit configured to open the respective output switch which is associated with the affected output terminal in response to detecting the short circuit and/or the disruption. For this purpose, the measuring device detects, for example, the level of the voltage and/or the strength of the electric current at the output terminal, while the control unit compares the detected values for the voltage and/or the electric current with a limiting value or limiting values, and detects a short circuit and/or a break in response to the result of the comparison. Thus, no additional components are necessary for detecting a short circuit and/or a disruption.

According to an additional specific embodiment, the power transmission device includes a buffer store for at least temporarily supplying at least the power transmission device with electric power. The buffer store may be a battery, a capacitor, or a rechargeable battery. With the aid of the buffer store, for example, the control unit and/or the measuring device of the power transmission device is/are also supplied with electric power, if no external electric power is available for operating the power transmission device, for example, during a switch from the first channel to the second channel or vice versa.

According to another specific embodiment, the power transmission device is designed to supply a consumer with electric power on two channels via two output terminals of the power transmission device. In this case, a dual-channel supply may be understood to mean that the consumer is optionally supplied with electric power via either the first or the second channel, or simultaneously via the two channels. As a result, the operating safety is further increased, since a consumer is redundantly supplied with electric power on two channels.

According to another specific embodiment, the power transmission device includes at least two output switches which are configurably designed as one changeover switch for supplying a consumer with electric power on two channels. Thus, if necessary, the power transmission device may be configured for supplying a consumer on two channels. In this case, the two output switches configured for one changeover switch cause the consumer to be supplied with electric power either via a first output switch or a second output switch. Therefore, the power transmission device may be used in a particularly flexible manner. The changeover switch may preferably be a mechanical switch or an electronic semiconductor switch.

According to another specific embodiment, a rectifier, in particular a diode, is associated with the at least one output terminal. This makes it possible to prevent feedback (for example, due to overvoltage in a consumer), and thus protects the remaining consumers from this overvoltage.

Preferably, the power transmission device also includes a data interface, in particular for a bus communication system, for example, CAN, via which a control unit of the power transmission device is able to communicate with other control units, in particular, in order to output or receive commands, status messages, etc.

Additional advantages and embodiments of the present invention result from the description herein and the figures.

It is understood that the aforementioned features and the features to be explained hereinafter are applicable not only in each specified combination, but also in other combinations or alone, without departing from the scope of the present invention. For example, the present invention may analogously also be used in battery-operated vehicles without an internal combustion engine.

The present invention is schematically depicted in the figures based on exemplary embodiments and is described in greater detail below with reference to the figures.

### BRIEF DESCRIPTION OF THE DRAWINGS

FIG. 1 shows a schematic representation of one exemplary embodiment of a vehicle electrical system according to the present invention.

FIG. 2 shows a schematic representation of one exemplary embodiment of a power transmission device according to the present invention for supplying consumers of the vehicle electrical system in FIG. 1.

### DETAILED DESCRIPTION OF EXAMPLE EMBODIMENTS

In the figures, identical or corresponding elements are specified using identical reference numerals. A repeated description will not be provided.

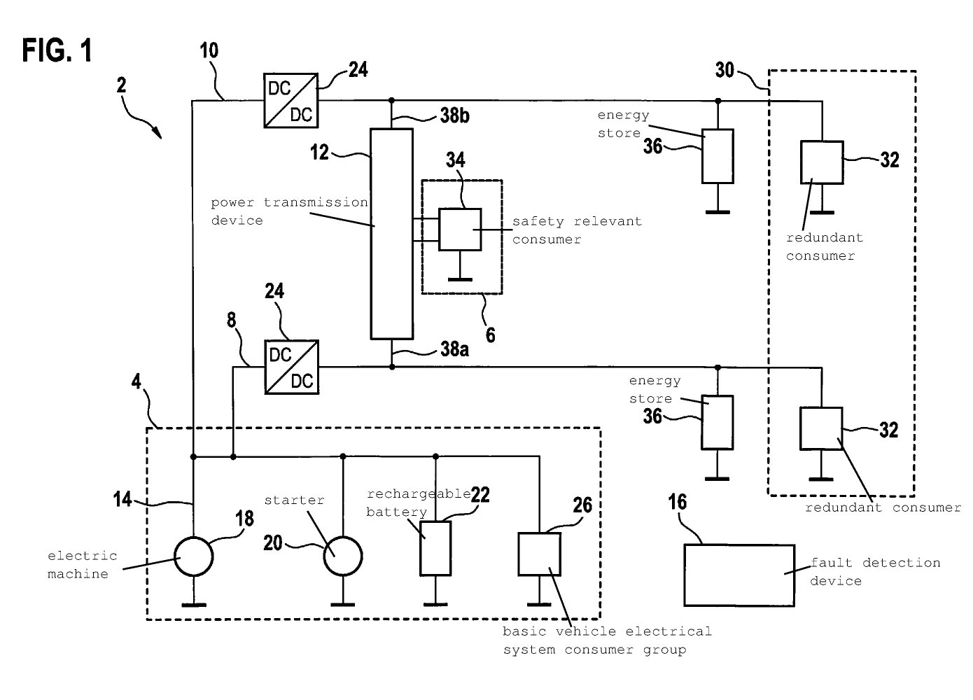

FIG. 1 shows one exemplary embodiment of a vehicle electrical system 2 according to the present invention. Vehicle electrical system 2 may in particular be part of a motor vehicle. Vehicle electrical system 2 includes, for example, a basic vehicle electrical system 4. In the present exemplary embodiment, basic vehicle electrical system 4 includes an electric machine 18. In the present exemplary embodiment, electric machine 18 may, for example, be operated as a motor, in order to be used as a drive, and/or operated as a generator, in order to generate electric power. For this purpose, a correspondingly designed power electronic system (not depicted) is provided. During generator operation, electric machine 18 is driven by an internal combustion engine of the vehicle. During motor operation, electric machine 18 may drive the vehicle.

In the present exemplary embodiment, in basic vehicle electrical system 4, a starter 20, a rechargeable battery 22, and a basic vehicle electrical system consumer group 26 are electrically connected in parallel with electric machine 18 via a connecting line 14. In the present exemplary embodiment, starter 20 is designed for starting an internal combustion engine of a motor vehicle. Electric power which has been generated by electric machine 18 during generator operation may be stored in rechargeable battery 22. Thus, basic vehicle electrical system consumer group 26 of basic vehicle electrical system 4 may be supplied with electric power by electric machine 18 during generator operation as well as by rechargeable battery 22. Thus, in the present exemplary embodiment, both electric machine 18 during generator operation and the rechargeable battery form a power source. Basic vehicle electrical system consumer group 26 may include one or a plurality of electrical consumers.

A first channel 8 and a second channel 10 (power supply channels) are electrically conductively connected to basic vehicle electrical system 4 and thus to the power source via connecting line 14.

In the present exemplary embodiment, one DC/DC converter 24 is associated in each case with first channel 8 and second channel 10, having the task of voltage conversion and decoupling channels 8, 10 from basic vehicle electrical system 4. Alternatively or in addition, one switching element (not depicted), for example, a semiconductor switch or a relay, may be associated in each case with first channel 8 and second channel 10, via which first channel 8 and/or second channel 10 may be electrically decoupled from basic vehicle electrical system 4 or the other channel 8 or 10 in each case.

In the present exemplary embodiment, one energy store 36 is connected on one channel in each case to first channel 8 and to second channel 10. In other words, each energy store 36 is electrically conductively connected only with first channel 8 or only with second channel 10. Energy stores 36 may include a rechargeable battery or a capacitor, for example, a double-layer capacitor. A power transmission device 12 is connected to a first connecting line 38a which is connected to first channel 8, and to a second connecting line 38b which is connected to second channel 10. Thus, power transmission device 12 is connected to vehicle electrical system 2 on two channels on the input side via the two channels 8, 10. On the output side, a consumer group 6 is connected to one or multiple safety-relevant consumers 34 at power supply device 12. A safety-relevant consumer 34 is, for example, a control unit for controlling safety-relevant electrical sensors and/or actuators, or simply existing safety-relevant sensors and/or actuators. Safety-relevant consumer 34 is, for example, designed for providing automatic driving functions. A particularly reliable supply of safety-relevant consumer 34 with electric power is to thereby be ensured.

In the case of a failure of basic vehicle electrical system 4, the supply of consumer group 6 including safety-relevant consumers 34 may be ensured with the aid of energy store 36. In this case, channels 8 and 10 are decoupled from basic vehicle electrical system 4 via the switching elements or DC/DC converter 24.

Furthermore, in the present exemplary embodiment, in each case, a redundant (i.e., present multiple times; twice here) consumer 32 of a redundant consumer assembly 30 is connected on one channel in each case to first channel 8 and to second channel 10. This means, redundant consumer assembly 30 is electrically conductively connected to the basic vehicle electrical system via first channel 8 and via second channel 10; however, each of redundant consumers 32 is connected only via exactly one channel 8, 10. A redundant consumer 32 may in particular be a safety-relevant electrical sensor or actuator, for example, a dual-circuit, electrically activatable brake of a motor vehicle, whose functionality is to continue to be available even in the case of a disconnection of one channel and in the case of a defect in one of consumers 32.

In addition, in the present exemplary embodiment, a fault detection device 16 is associated with vehicle electrical system 2. Fault detection device 16 is equipped with one or multiple devices for detecting faults in the basic vehicle electrical system, channels 8 and 10, or consumers 32, in order to be able to detect faults such as overvoltage, undervoltage, short circuits, or line disruptions. Furthermore, fault detection device 16 is electrically conductively connected to DC/DC converters 24 via control lines (not shown), in order to control them in the event of a fault in such a way that the supply of consumer group 30 is ensured in the event of a fault. As described, this may, for example, take place by decoupling channels 8 and/or 10 from the basic vehicle electrical system.

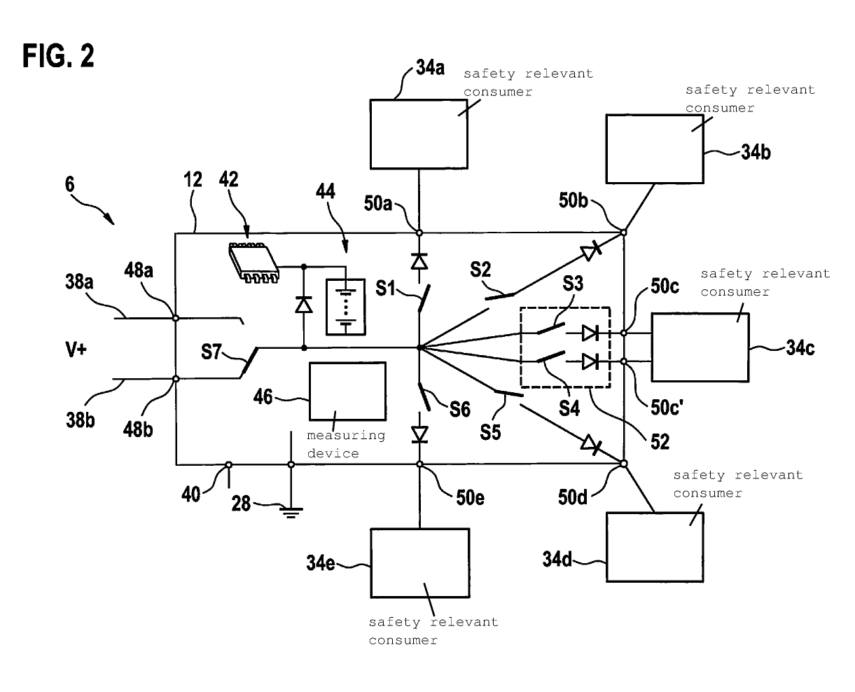

FIG. 2 shows that consumer group 6 in the present exemplary embodiment has five safety-relevant consumers 34a, 34b, 34c, 34d, 34e. In the present exemplary embodiment, consumers 34a, 34b, 34c, 34d, 34e are components which are designed for providing automatic driving functions and must therefore be reliably supplied with electric power, for example, a control unit for controlling safety-relevant electrical sensors and/or actuators, or safety-relevant sensors and/or actuators.

In the present exemplary embodiment, power transmission device 12 includes two input terminals 48a, 48b which are electrically conductively connected in each case with the two channels 8, 10 (which are at a voltage supply potential V+ here). In addition, in the present exemplary embodiment, power transmission device 12 includes six output terminals 50a, 50b, 50c, 50c′, 50d, 50e.

Thus, power transmission device 12 is connected on the input side to first channel 8, and to second channel 10 for dual-channel transmission of electric power. Furthermore, FIG. 2 shows that consumers 34a, 34b, 34d, 34e are connected to power transmission device 12 for the single-channel transmission of electric power, while consumer 34c is connected via the two output terminals 50c, 50c′ for the dual-channel transmission of electric power. In the present exemplary embodiment, in addition, power transmission device 12 includes a ground terminal 28 and an interface 40 to a vehicle bus, for example, a CAN bus. Alternatively, interface 40 may be designed to be LIN-compatible or Ethernet-compatible.

Power transmission device 12 includes a control device 42 which, in the present exemplary embodiment, includes a microcontroller. To supply control device 42 with electric power in the case of a glitch in the supply voltage, power transmission device 12 furthermore includes a buffer store 44.

Furthermore, in the present exemplary embodiment, power transmission device 12 includes six output switches S1, S2, S3, S4, S5, S6, via which output terminals 50a, 50b, 50c, 50c′, 50d, 50e may be disconnected from a supply with electric power. The electrical lines connected to output terminals 50a, 50b, 50c, 50c′, 50d, 50e radially connect power transmission device 12 to consumers 34a, 34b, 34c, 34d, 34e. Output switches S1, S2, S3, S4, S5, S6 may be mechanical switches or semiconductor switches. In addition, in the present exemplary embodiment, a protective diode is associated with each output line for protecting power transmission device 12. This makes it possible to prevent feedback (for example, due to overvoltage in one of consumers 34a, 34b, 34c, 34d, 34e), and thus protects the remaining consumers from this overvoltage.

Control device 42 is operatively connected to output switches S1, S2, S3, S4, S5, S6 via control lines, which are not depicted, in such a way that control device 42 is able to optionally open or close each of output switches S1, S2, S3, S4, S5, S6.

Finally, power transmission device 12 includes a measuring device 46. In the present exemplary embodiment, measuring device 46 is designed for measuring voltage and/or electric current. With the aid of measuring device 46, short circuits to each other or to V+ and/or ground and/or line disruptions in the output lines may be detected.

Control device 42 is configured to read out a measured value from measuring device 46 during operation, via signal lines which are not depicted, and to evaluate whether there is a short circuit between one of output terminals 50a, 50b, 50c, 50c′, 50d, 50e and ground, and/or a disruption in an electrical line connected to one of the at least two output terminals 50a, 50b, 50c, 50c′, 50d, 50e. If this is the case, during operation, control device 42 controls respective output switch S1, S2, S3, S4, S5, S6 in order to disconnect the line connected to affected output terminal (50a, 50b, 50c, 50c′, 50d, 50e). However, the other output switches S1, S2, S3, S4, S5, S6 remain unchanged. Thus, the power supply to remaining consumers 34a, 34b 34c, 34d, 34e is unaffected by the fault.

However, as in the case of consumer 34c, if a dual-channel supply is provided, control device 42 normally controls output switches S3 and S4 in such a way that only one of the two output switches S3 and S4 is closed, while the other one of output switches S3 and S4 is open. Thus, in the present exemplary embodiment, the two output switches S3 and S4 which are associated with output terminals 50c, 50c′ are configured as a changeover switch S2. In the event of a fault, a switch is made to the other one of output terminals 50c, 50c′.

Power transmission device 12 furthermore includes an input switch S7. With the aid of input switch S7, it may be selected whether an electric power supply is to take place via first channel 8 or second channel 10. For this purpose, in the present exemplary embodiment, input switch S7 is designed as a changeover switch. It is thus ensured that a supply does not take place simultaneously via first channel 8 and second channel 10. This enables a switchover of the supply in the event of a fault. The changeover switch may be a mechanical switch or a semiconductor switch.

During operation, it is selected whether a power supply takes place via first channel 8 or second channel 10. For selecting first channel 8 or second channel 10, the level of the available voltage across first channel 8 and second channel 10 and/or the strength of the electric current is detected using a measuring device 46. For this purpose, measuring device 46 is designed for measuring the voltage and/or the electric current available across first channel 8 and second channel 10. Control device 42 is designed for comparing the measuring result with a lower limiting value for the voltage and/or for the electric current. If the measured voltage falls below a lower limiting value, a supply voltage fault is assumed, and a switch is made from the active channel to the other channel. Alternatively, a signal for changing from the one channel to the other channel may also be transmitted from a higher-level power management system of the vehicle to power transmission device 12 using the vehicle bus.

Likewise, a dual-channel power supply may take place via first channel 8 and second channel 10 simultaneously, a faulty channel being disconnected only in the event of a fault.

According to a further specific embodiment, power transmission device 12 is not designed as a separate component as shown in FIG. 2, but rather, for example, as integrated into consumer 34c. In this case, the output lines extend radially from consumer 34c to the other consumers 34a, 34b, 34d, 34e. This specific embodiment is particularly suitable as special equipment for vehicles and has a high level of integration density. Integration into one or more of the basic vehicle electrical system consumers of basic vehicle electrical system consumer groups 26, in particular into the so-called body control unit (or another control unit), is also advantageous.

1-13. (canceled)

14. A power transmission device, comprising:
at least a first input terminal and a second input terminal for at least dual-channel supply of electric power to the power transmission device;
at least one output terminal for routing the electric power to a consumer; and
an input switch designed for an electrically conductive connection of at least one of the first input terminal and the second input terminal, to the at least one output terminal.

15. The power transmission device as recited in claim 14, wherein the input switch is a changeover switch.

16. The power transmission device as recited in claim 14, which is designed to control the input switch in such a way that a switch from the first input terminal to the second input terminal or vice-versa is carried out, at least one of: in response to the detection of an undershooting of a limiting value for the level of a voltage, for strength of an electric current at the first input terminal, for strength of an electric current at the second input terminal.

17. The power transmission device as recited in claim 14, further comprising:
an output switch for disconnecting the electrically conductive connection of at least one of the first input terminal and the second input terminal, the output switch being associated with the at least one output terminal.

18. The power transmission device as recited in claim 14, wherein a rectifier is associated with the at least one output terminal.

19. The power transmission device as recited in claim 14, which is designed for radially supplying consumers with electric power.

20. The power transmission device as recited in claim 14, further comprising:
a measuring device which is designed for detecting at least one of: i) a short circuit between the at least one output terminal and at least one of a voltage supply potential, ii) a short between the at least one output terminal and at least one additional output terminal, and iii) a disruption in an electrical line connected to the at least one output terminal;
wherein the power transmission device is configured to open the respective output switch which is associated with the affected output terminal in response to the detection of the at least one of the short circuit and the disruption.

21. The power transmission device as recited in claim 14, further comprising:
a control device which controls operation of the power transmission device.

22. The power transmission device as recited in claim 21, further comprising:
a data interface which is connected to the control device.

23. The power transmission device as recited in claim 14, further comprising:
a buffer store for at least temporarily supplying at least the power transmission device with electric power.

24. The power transmission device as recited in claim 14, which is designed to supply a consumer with electric power on two channels using two output terminals.

25. The power transmission device as recited in claim 24 further comprising:
at least two output switches which are configurably designed as a changeover switch for the dual-channel supply of a consumer with electric power.

26. A vehicle electrical system including a power transmission device, the power transmission device comprising:
at least a first input terminal and a second input terminal for at least dual-channel supply of electric power to the power transmission device;
at least one output terminal for routing the electric power to a consumer; and
an input switch designed for an electrically conductive connection of at least one of the first input terminal and the second input terminal, to the at least one output terminal.
